(19) United States
(12) Patent Application Publication
(10) Pub. No.: US 2014/0002771 A1
(43) Pub. Date: Jan. 2, 2014

(54) LIGHT SOURCE ASSEMBLY, BACKLIGHT MODULE AND LIQUID CRYSTAL DISPLAY DEVICE

(71) Applicant: Synergy Optoelectronics (Shenzhen) Co., Ltd., Shenzhen (CN)

(72) Inventors: SIN-TUNG HUANG, Hsinchu (TW); WUN-CI KANG, Hsinchu (TW)

(21) Appl. No.: 13/929,785

(22) Filed: Jun. 28, 2013

(30) Foreign Application Priority Data
Jun. 28, 2012 (CN) 2012102175336

(51) Int. Cl. G02F 1/1335; G02B 5/02; F21V 8/00

(52) U.S. Cl. CPC G02F 1/133615; G02B 6/0011; G02B 5/02
USPC 349/64; 362/612; 362/235

(57) ABSTRACT

A liquid crystal display includes a liquid crystal panel and a backlight module. The backlight module includes a light guide plate, a light source assembly, and a diffusion member. The diffusion member is disposed between LEDs of the light source assembly and a light incident surface of the light guide plate. The diffusion member includes a first transparent layer adjacent to the LEDs and a second transparent layer adjacent to the light guide plate. A refractive index of the first transparent layer is greater than that of the second transparent layer, and a refractive index of the second transparent layer is greater than that of the light guide plate.

### BACKGROUND

1. Technical Field

The present disclosure relates to a light source assembly with a diffusion member and a backlight module and a liquid crystal display using the light source assembly.

2. Description of Related Art

A typical liquid crystal display employs a number of light emitting diodes (LEDs) as a light source of a backlight module. The size of the backlight module can be reduced by decreasing the distance between the LEDs and a light incident surface of the light guide plate. However, the maximum divergent angle of light emitted by the LEDs is limited. If the light incident surface is too close to the LEDs, some areas of the light incident surface between two adjacent LEDs may fail to receive the light and be relatively dark, causing the light emitted from the backlight module to be non-uniform and the performance of an associated LCD to be visibly impaired.

What is needed, therefore, is a means to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded view of a liquid crystal display according to a first embodiment of the present disclosure. The liquid crystal display includes a liquid crystal display panel, a frame, a light guide plate, a reflector, a light source, a diffusion member, and a number of optical films.

FIG. 2 is a partial plan view of the light guide plate, the diffusion member, and the LEDs of the light source of FIG. 1.

FIG. 3 is an isometric view of the diffusion member of the liquid crystal display according to a second embodiment of the present disclosure.

### DETAILED DESCRIPTION

Reference will be made to the drawings to describe various embodiments.

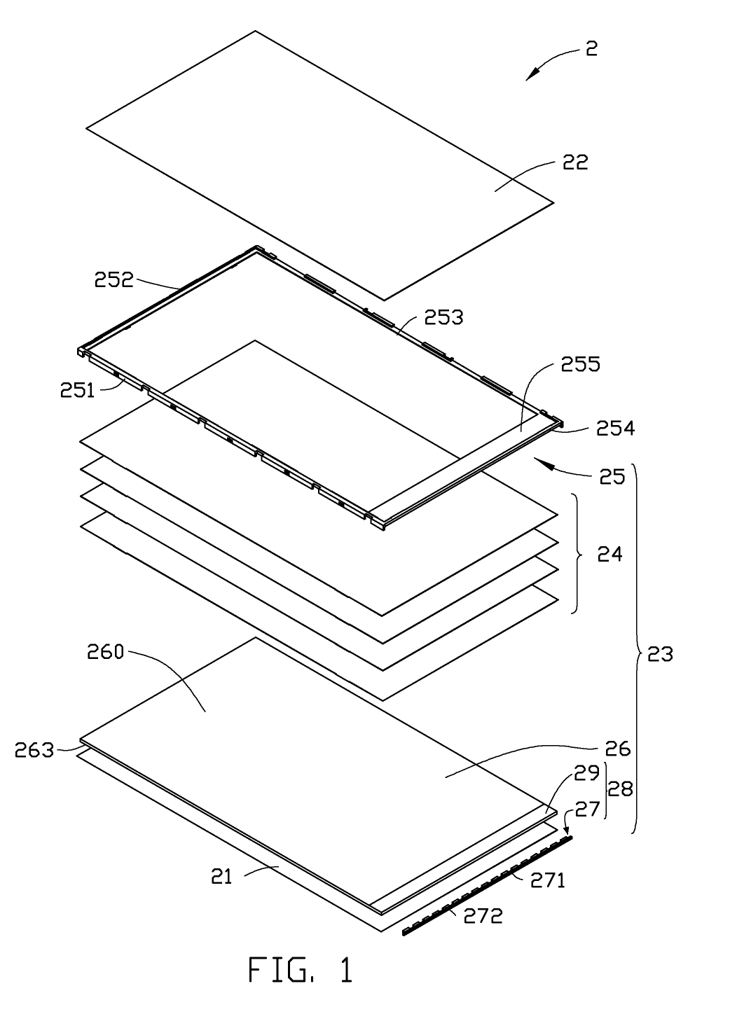

Referring to FIG. 1, in a first embodiment, a liquid crystal display 2 includes a liquid crystal panel 22 and a backlight module 23 providing light beams to the liquid crystal panel 22.

The backlight module 23 includes a number of optical films 24, a light guide plate 26, a light source assembly 28, a reflector 21, and a frame 25. The optical films 24, the light guide plate 26, the light source assembly 28, and the reflector 21 are received in the frame 25.

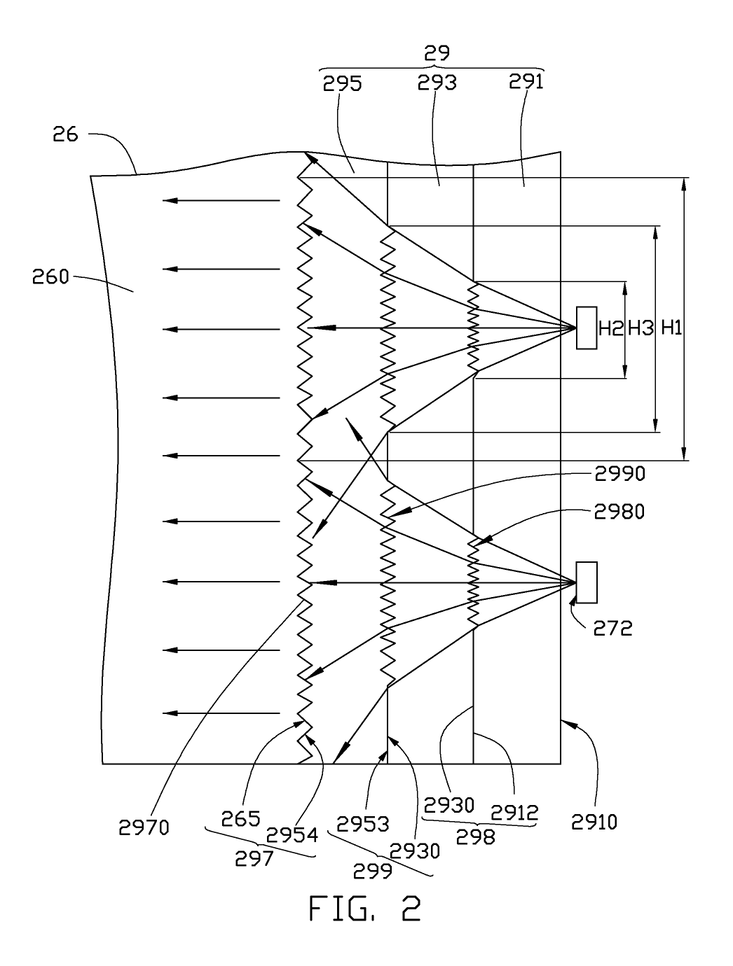

Referring also to FIG. 2, the light guide plate 26 includes a lateral light incident surface 265, a top light emitting surface 260 substantially perpendicular to the light incident surface 265, and a bottom surface 263 opposite to the top light emitting surface 260.

The light source assembly 28 faces toward the light incident surface 265 and includes a light source 27 and a diffusion member 29. The light source 27 includes a circuit board 271 and a number of LEDs 272 attached on the circuit board 271. Light beams emitted from each LED 272 forms an optic axis of each LED 272.

The diffusion member 29 includes a first transparent layer 291, a second transparent layer 295, and an interlayer 293 sandwiched between the first and second transparent layers 291 and 295. The interlayer 293 is transparent and includes at least one layer. In this embodiment, the interlayer 293 includes only one layer. The first transparent layer 291, the interlayer 293, and the second transparent layer 295 are stacked together. The diffusion member 29 is sandwiched between the LEDs 272 and the light incident surface 265 of the light guide plate 26. The first transparent layer 291 is adjacent to the LEDs 272, and the second transparent layer 295 is attached on the light incident surface 265 of the light guide plate 26. A main plane of each of the first transparent layer 291, the interlayer 293, and the second transparent layer 295 is substantially parallel with the light incident surface 265. A refractive index of the first transparent layer 291 is greater than a refractive index of the interlayer 293, the refractive index of the interlayer 293 is greater than a refractive index of the second transparent layer 295, and the refractive index of the second transparent layer 295 is greater than a refractive index of the light guide plate 26.

The first transparent layer 291 comprises a first surface 2910 facing the LEDs 272 and a second surface 2912 opposite to the first surface 2910. The second transparent layer 295 comprises a third surface 2953 and a fourth surface 2954 opposite to the third surface 2953. The fourth surface 2954 faces the light incident surface 265 of the light guide plate 26. The interlayer 293 includes two opposite surfaces 2930. The second surface 2912 of the first transparent layer 291 forms a first interface 298 with a surface 2930 of the interlayer 293. The fourth surface 2954 of the second transparent layer 295 forms a second interface 297 with the light incident surface 265 of the light guide plate 26. The other surface 2930 of the interlayer 293 forms a third interface 299 with the third surface 2953 of the second transparent layer 295.

The first interface 298 between the first transparent layer 291 and the interlayer 293 includes complementary first light diffusing microstructures 2980. The second interface 297 between the second transparent layer 295 and the light guide plate 26 includes complementary second light diffusing microstructures 2970. The third interface 299 between the interlayer 293 and the second transparent layer 295 includes complementary third light diffusing microstructures 2990. The first light diffusing structures 2980 diverge the light beams emitted from the respective LED 272, the third light diffusing structures 2990 diverge the light beams diverged by the first light diffusing structures 2980, and the second light diffusing structures 2970 diverge the light beams diverged by the third light diffusing structures 2990.

The first light diffusing microstructures 2980 includes a plurality of groups of microstructures, each group of the microstructures of the first light diffusing microstructures 2980 aligned with the optic axis of a respective LED 272. The third light diffusing microstructures 2990 includes a plurality of groups of microstructures, each group of the microstructures of the third light diffusing microstructures 2990 aligned with the optic axis of a respective LED 272. The second light diffusing microstructures 2970 includes a plurality of groups of microstructures, each group of the microstructures of the second light diffusing microstructures 2970 aligned with the optic axis of a respective LED 272.

Each group of the microstructures of the first light diffusing microstructures 2980 are separated from each other, and the first interface 298 includes a plurality of flat portions separating the first light diffusing microstructures 2980 into the separated groups. Each group of the microstructures of the third light diffusing microstructures 2990 are separated from each other, and the third interface 299 includes a plurality of flat portions separating the third light diffusing microstructures 2990 into the separated groups.

Distribution densities of each group of microstructures of the first, second, and third light diffusing microstructures gradually decrease in a direction away from the optic axis of their respective LED 272.

The frame 25 includes four sidewalls 251, 252, 253, and 254 connected end to end and a horizontal supporting wall 255 inwardly extending from the four sidewalls 251, 252, 253, and 254. The horizontal supporting wall 255 defines a window (not labeled) corresponding to a display screen of the liquid crystal panel 22. The four sidewalls 251, 252, 253, and 254 and the horizontal supporting wall 255 define a first accommodating space (not labeled) above the horizontal supporting wall 255 and a second accommodating space (not labeled) behind the horizontal supporting wall 255.

In assembly of the liquid crystal display 2, the liquid crystal panel is arranged on the horizontal supporting wall 255 and received in the first accommodating space. The light source assembly 28, the optical films 24, the light guide plate 26, and the reflector 21 are received in the second accommodating space. The optical films 24, the light guide plate 26, and the reflector 21 are arranged from top to bottom and correspond to the liquid crystal panel 22. The light source assembly 28 is adjacent to the light incident surface 265 of the light guide plate 26.

With the above-described configuration, the diffusion member 29 is sandwiched between the LEDs 272 and the light guide plate 26, and the refractive indexes of the first transparent layer 291, the interlayer 293, and the second transparent layer 295 decrease from the LEDs 272 to the light guide plate 26. Therefore, the divergent angle of the light beams emitted by the LEDs 272 expands when the light beams transmit to the light guide plate 26, such that the light beams emitted from the LEDs 272 reach more area of the light incident surface 265 of the light guide plate 26. Therefore, the dark areas of the above-described conventional light guide plate are reduced. As a result, an improved uniformity of brightness of the backlight module 23 is achieved, and the performance of an associated LCD is visibly improved.

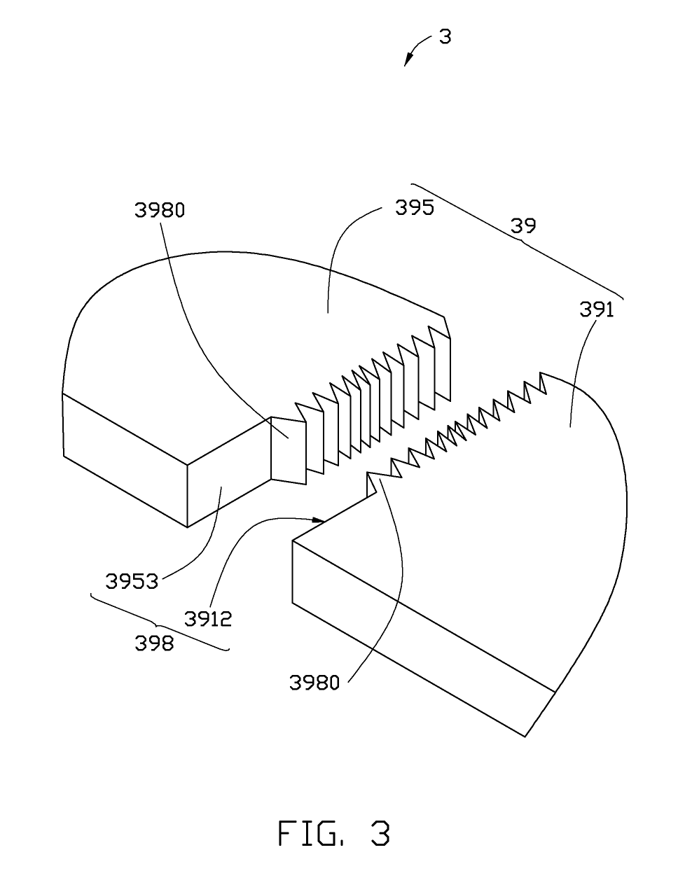

Referring to FIG. 3, a liquid crystal display 3 according to a second embodiment of the present disclosure is shown. The structure of the liquid crystal display 3 is similar to that of the liquid crystal display 2, except that the structure of the diffusion member 39 is a two-layer structure. The diffusion member 39 only includes the first and second transparent layers 391 and 395. The second surface 3912 of the first transparent layer 391 and the third surface 3953 of the second transparent layer 395 form the first interface 398. The first interface 398 between the first transparent layer 391 and the interlayer 395 includes complementary first light diffusing microstructures 3980.

The first light diffusing structures 3980 diverge the light beams emitted from the respective LED, and the second light diffusing structures of the second interface between second transparent layer and the light guide plate diverge the light beams diverged by the first light diffusing structures 3980.

Distribution densities of each group of microstructures of the first and second light diffusing microstructures gradually decrease in a direction away from the optic axis of their respective LED.

The diffusion member herein is not limited to the above-described embodiments. The number of the layers of the diffusion member can be configured according to particular requirements, two-layer, three-layer, or more-layer can be employed. The diffusion member includes at least two layers.

It is believed that the present embodiments and their advantages will be understood from the foregoing description, and it will be apparent that various changes may be made thereto without departing from the spirit and scope of the description or sacrificing all of their material advantages, the examples hereinbefore described merely being exemplary embodiments.

What is claimed is:

1. A backlight module comprising:
a light guide plate comprising a light incident surface; and
a light source assembly facing toward the light incident surface and comprising:
a plurality of light emitting diodes (LEDs), light beams emitted from each LED forms an optic axis of each LED; and
a diffusion member disposed between the LEDs and the light incident surface of the light guide plate, the diffusion member comprising a first transparent layer and a second transparent layer, the first transparent layer stacked on the second transparent layer, the second transparent layer attached on the light incident surface, the first transparent layer adjacent to the LEDs, a main plane of each of the first and second transparent layers being substantially parallel with the light incident surface;
wherein a refractive index of the first transparent layer is greater than a refractive index of the second transparent layer, and the refractive index of the second transparent layer is greater than a refractive index of the light guide plate.

2. The backlight module of claim 1, wherein the first transparent layer comprises a first surface facing the LEDs and a second surface opposite to the first surface, the second transparent layer comprises a third surface and a fourth surface opposite to the third surface, the fourth surface faces the light incident surface of the light guide plate.

3. The backlight module of claim 2, further comprising a plurality of first light diffusing structures arranged between a first interface between the second surface of the first transparent layer and the third surface of the second transparent layer, and a plurality of second light diffusing microstructures arranged between a second interface between the light incident surface of the light guide plate and the fourth surface of the second transparent layer.

4. The backlight module of claim 3, wherein the first light diffusing microstructures are configured to diverge the light beams emitted from each of the LEDs, and the second light diffusing microstructures are configured to further diverge the light beams diverged by the first light diffusing microstructures.

5. The backlight module of claim 3, wherein the first light diffusing microstructures includes a plurality of separated groups of microstructures, each group of the microstructures aligned with an optic axis of a respective LED, a distribution density of each group of microstructures gradually decreases in a direction away from the optic axis.

6. The backlight module of claim 5, wherein the first interface includes a plurality of flat portions separating the first light diffusing microstructures into the separated groups.

7. The backlight module of claim 3, wherein the second light diffusing microstructures includes a plurality of groups of microstructures, each group of the microstructures aligned with an optic axis of a respective LED, a distribution density of each group of microstructures gradually decreases in a direction away from the optic axis.

8. A liquid crystal display comprising:
a liquid crystal panel; and
a backlight module configured for providing light beams to the liquid crystal panel, the backlight module comprising:
a light guide plate comprising a light incident surface; and
a light source assembly facing toward the light incident surface and comprising:
a plurality of light emitting diodes (LEDs), light beams emitted from each LED forms an optic axis of each LED; and
a diffusion member disposed between the LEDs and the light incident surface of the light guide plate, the diffusion member comprising a first transparent layer and a second transparent layer, the first transparent layer stacked on the second transparent layer, the second transparent layer attached on the light incident surface, the first transparent layer adjacent to the LEDs, a main plane of each of the first and second transparent layers being substantially parallel with the light incident surface;
wherein a refractive index of the first transparent layer is greater than a refractive index of the second transparent layer, and the refractive index of the second transparent layer is greater than a refractive index of the light guide plate.

9. The liquid crystal display of claim 8, wherein the first transparent layer comprises a first surface facing the LEDs and a second surface opposite to the first surface, the second transparent layer comprises a third surface and a fourth surface opposite to the third surface, the fourth surface faces the light incident surface of the light guide plate.

10. The liquid crystal display of claim 9, further comprising a plurality of first light diffusing structures arranged between a first interface between the second surface of the first transparent layer and the third surface of the second transparent layer, and a plurality of second light diffusing microstructures arranged between a second interface between the light incident surface of the light guide plate and the fourth surface of the second transparent layer.

11. The liquid crystal display of claim 10, wherein the first light diffusing microstructures are configured to diverge the light beams emitted from each of the LEDs, and the second light diffusing microstructures are configured to further diverge the light beams diverged by the first light diffusing microstructures.

12. The liquid crystal display of claim 10, wherein the first light diffusing microstructures includes a plurality of separated groups of microstructures, each group of the microstructures aligned with an optic axis of a respective LED, a distribution density of each group of microstructures gradually decreases in a direction away from the optic axis.

13. The liquid crystal display of claim 12, wherein the first interface includes a plurality of flat portions separating the first light diffusing microstructures into the separated groups.

14. The liquid crystal display of claim 10, wherein the second light diffusing microstructures includes a plurality of groups of microstructures, each group of the microstructures aligned with an optic axis of a respective LED, a distribution density of each group of microstructures gradually decreases in a direction away from the optic axis.

15. A light source assembly comprising:
a plurality of light emitting diodes (LEDs), light beams emitted from each LED forms an optic axis of each LED; and
a diffusion member comprising a first transparent layer and a second transparent layer, the first transparent layer stacked on the second transparent layer, the first transparent layer adjacent to the LEDs;
wherein a refractive index of the first transparent layer is greater than a refractive index of the second transparent layer.

16. The light source assembly of claim 15, wherein the first transparent layer comprises a first surface facing the LEDs and a second surface opposite to the first surface, the second transparent layer comprises a third surface and a fourth surface opposite to the third surface, and the second surface faces the third surface.

17. The liquid crystal display of claim 16, further comprising a plurality of first light diffusing structures arranged between a first interface between the second surface of the first transparent layer and the third surface of the second transparent layer, and a plurality of second light diffusing microstructures arranged on the fourth surface of the second transparent layer.

18. The liquid crystal display of claim 17, wherein the first light diffusing microstructures are configured to diverge the light beams emitted from each of the LEDs, and the second light diffusing microstructures are configured to further diverge the light beams diverged by the first light diffusing microstructures.

19. The liquid crystal display of claim 17, wherein the first light diffusing microstructures includes a plurality of separated groups of microstructures, each group of the microstructures aligned with an optic axis of a respective LED, a distribution density of each group of microstructures gradually decreases in a direction away from the optic axis.

20. The liquid crystal display of claim 17, wherein the second light diffusing microstructures includes a plurality of groups of microstructures, each group of the microstructures aligned with an optic axis of a respective LED, a distribution density of each group of microstructures gradually decreases in a direction away from the optic axis.
